(19) United States
(12) Patent Application Publication
(10) Pub. No.: US 2026/0336350 A1
(43) Pub. Date: Oct. 29, 2026

(54) VEHICLE CONTROL DEVICE AND STORAGE MEDIUM

(71) Applicant: TOYOTA JIDOSHA KABUSHIKI KAISHA, Toyota-shi (JP)

(72) Inventors: Yuko TAKAHIRA TSUDA, Shizuoka-ken (JP); Tomoyasu TAMAOKI, Okazaki-shi (JP); Yusuke TATESUMI, Seto-shi (JP)

(73) Assignee: TOYOTA JIDOSHA KABUSHIKI KAISHA, Toyota-shi (JP)

(21) Appl. No.: 19/447,504

(22) Filed: Jan. 13, 2026

(30) Foreign Application Priority Data
Mar. 6, 2025 (JP) 2025-035459

(51) Int. Cl. B60G 17/019

(52) U.S. Cl. CPC B60G 17/019; B60G 2400/05; B60G 2400/252; B60G 2401/14; B60G 2800/7022; B60G 2800/914

(57) ABSTRACT

A vehicle control device including a controller configured to control a camera device provided in a vehicle having a ride height that is adjustable, in which the controller is configured to adjust, when the vehicle is in a state in which the ride height is determined to be higher than a standard state based on a detection value of the ride height, an optical axis of the camera device by using an attitude-change correction value that is set in advance for correcting the optical axis of the camera device in accordance with the ride height.

### CROSS-REFERENCE TO RELATED APPLICATION

This application claims priority to Japanese Patent Application No. 2025-035459 filed on Mar. 6, 2025. The disclosure of the above-identified application, including the specification, drawings, and claims, is incorporated by reference herein in its entirety.

### BACKGROUND

### 1. Technical Field

The present disclosure relates to a vehicle control device and a storage medium that can control an external camera.

### 2. Description of Related Art

Japanese Unexamined Patent Application Publication No. 2017-143417 (JP 2017-143417 A) discloses a technique for calibrating an external camera provided in a vehicle. The technique disclosed in JP 2017-143417 A includes an imaging unit provided in a vehicle, calculates a reliability of an attitude sensor provided in the vehicle, and calculates an external parameter of the imaging unit based on attitude information output by the attitude sensor and a relationship between a coordinate system of the imaging unit and a vehicle coordinate system when the reliability is greater than a predetermined threshold value.

### SUMMARY

A ride height adjustment device that temporarily raises a ride height may be provided in order to overcome a road surface unevenness or the like. According to the related art, in a case where the ride height of the vehicle is temporarily changed, calibration of the external camera based on complicated computational processing needs to be performed. In addition, according to the related art, in a case of performing learning for calibration, a certain speed and time are needed. Therefore, in a case where the ride height is changed based on the ride height adjustment device that operates temporarily for a short time, learning for calibrating an optical axis may fail to keep pace, resulting in a decrease in system accuracy.

An object of the present disclosure is to provide a vehicle control device and a computer program that can simplify computational processing in calibration for adjusting an optical axis of a camera device when a ride height of a vehicle is temporarily changed.

A vehicle control device according to a first aspect of the present disclosure includes a controller configured to control a camera device provided in a vehicle having a ride height that is adjustable, in which the controller is configured to adjust, when determination is made that the vehicle is in a state in which the ride height is higher than a standard state based on a detection value of the ride height of the vehicle, an optical axis of the camera device by using an attitude-change correction value that is set in advance for correcting the optical axis of the camera device in accordance with the ride height.

According to the present disclosure, computational processing in calibration for adjusting an optical axis of a camera device can be simplified.

In the vehicle control device according to the first aspect of the present disclosure, the controller is configured to adjust, when the detection value is a predetermined detection value indicating the ride height that is predetermined and set in advance, the optical axis by using the attitude-change correction value that is set in advance in accordance with the predetermined detection value.

In the vehicle control device according to the first aspect of the present disclosure, the controller is configured to calculate an attitude change amount of the vehicle based on the predetermined detection value and a set value of a wheelbase of the vehicle, and calculate the attitude-change correction value based on the attitude change amount.

In the vehicle control device according to the first aspect of the present disclosure, the controller is configured to execute, when the detection value is not acquired, determination processing based on imaging data of the camera device to adjust the optical axis of the camera device.

A storage medium according to a second aspect of the present disclosure stores a computer program that is installed on a computer that is configured to control a camera device provided in a vehicle having a ride height that is adjustable, the program causing the computer to execute adjusting, when determination is made that the vehicle is in a state in which the ride height is higher than a standard state based on a detection value of the ride height of the vehicle, an optical axis of the camera device by using an attitude-change correction value that is set in advance for correcting the optical axis of the camera device in accordance with the ride height.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a vehicle in which a vehicle control device is mounted;

FIG. 2 is a diagram showing a state in which a ride height of the vehicle is adjusted; and

FIG. 3 is a flowchart showing a flow of processing of a vehicle control method executed in the vehicle control device.

### DETAILED DESCRIPTION OF EMBODIMENTS

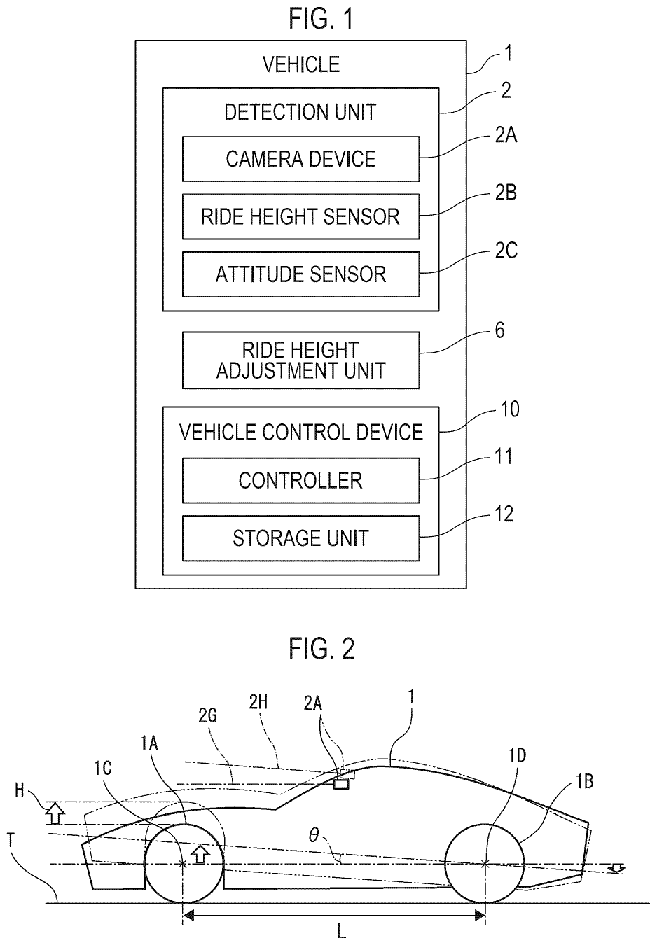

As shown in FIG. 1, a vehicle 1 includes a detection unit 2 that detects a detection value necessary for traveling, a ride height adjustment unit 6 that adjusts a ride height, and a vehicle control device 10 that executes control necessary for traveling. The detection unit 2 includes, for example, a camera device 2A that captures an image of an external environment of the vehicle 1. The camera device 2A is mounted to capture an image of an environment in front of the vehicle 1 from inside the vehicle 1, for example. One or more camera devices 2A may be provided and mounted to capture an image of a lateral environment of the vehicle 1 or a rearward environment of the vehicle 1. The camera device 2A has an optical axis adjusted by the vehicle control device 10 as described below.

The detection unit 2 includes a ride height sensor 2B that detects the ride height of the vehicle 1. The ride height sensor 2B detects the ride height based on a control signal corresponding to an operation state of the ride height adjustment unit 6. The ride height sensor 2B may detect the ride height steplessly, or may detect at least two stages of the ride height in a stepwise manner, such as a first state indicating a state in which the ride height is high or a second state indicating a standard state of the ride height. The ride height sensor 2B may use other sensors as long as the ride height of the vehicle 1 can be detected.

The detection unit 2 includes an attitude sensor 2C that detects an attitude of the vehicle 1. The attitude sensor 2C is configured by a three-axis or more angular velocity sensor that can detect a change in a pitching angle, a yaw angle, and a roll angle of the vehicle 1. The attitude sensor 2C may use other sensors as long as the attitude change of the vehicle 1 can be detected. The detection unit 2 outputs the detection value to the vehicle control device 10.

The ride height adjustment unit 6 is configured to change a height of a vehicle body of the vehicle 1 with respect to the ground based on an operation of a driver of the vehicle 1. The ride height adjustment unit 6 is provided in, for example, a damper device that supports front wheels of the vehicle 1. The ride height adjustment unit 6 is configured to extend the damper device to raise a ride height of a front portion of the vehicle body with respect to the ground. The ride height adjustment unit 6 includes, for example, an actuator that is extended or shortened based on inflow and outflow of an operating fluid.

The ride height adjustment unit 6 may be configured to adjust the ride height steplessly based on an extended state of the actuator, for example. The ride height adjustment unit 6 may be configured to adjust the ride height in two stages to reach a predetermined ride height relative to the ride height of the standard state based on the extended state of the actuator. The ride height adjustment unit 6 may be configured to adjust the ride height in a stepwise manner in two or more stages. The ride height adjustment unit 6 may be provided in a damper device that supports rear wheels of the vehicle 1. The ride height adjustment unit 6 is controlled by the vehicle control device 10.

The vehicle control device 10 includes a controller 11 that executes computation and control necessary for traveling of the vehicle 1, and a storage unit 12 that stores data and a computer program necessary for the control. The controller 11 is configured by a hardware processor such as at least one central processing unit (CPU). The controller 11 may be implemented by hardware such as a large scale integration (LSI), an application specific integrated circuit (ASIC), a field-programmable gate array (FPGA), or a graphics processing unit (GPU), or may be implemented by cooperation between software and hardware.

The storage unit 12 is configured by a non-transitory storage medium such as a hard disk drive (HDD) or a solid state disk (SSD). The computer program may be stored in advance in a storage device (a storage device including a non-transitory storage medium) such as an HDD or a flash memory of the storage unit 12. In addition, the computer program may be stored in a removable storage medium such as a DVD or a CD-ROM, and may be installed in the HDD or the flash memory of the storage unit 12 by mounting the storage medium (non-transitory storage medium) on a drive device.

The controller 11 is configured to control the camera device 2A provided in the vehicle 1 having a ride height that is adjustable. The controller 11 is configured to execute a driving assistance control during traveling of the vehicle 1 based on the imaging data captured by the camera device 2A. The controller 11 is configured to recognize an object present around the vehicle 1 by executing machine learning such as deep learning in advance using, for example, a captured image in which a road environment is imaged, as training data.

The controller 11 is configured to recognize a target object necessary for the traveling of the vehicle 1, such as another vehicle, a road structure, a pedestrian, an object, a vehicle lane, and a sign, imaged in the imaging data captured by the camera device 2A, and execute a driving assistance function provided in the vehicle 1. The driving assistance function is executed based on, for example, the imaging data, and includes a lane departure prevention function of preventing the vehicle 1 from deviating from a vehicle lane, an automatic brake function of preventing the vehicle 1 and the object from approaching each other within a predetermined distance, and an autonomous following traveling function of following a preceding vehicle.

The controller 11 executes learning during driving to improve a recognition performance for an environment around the vehicle 1 based on the imaging data during traveling of the vehicle 1. The controller 11 is configured to execute learning during driving based on the imaging data and execute the optical axis adjustment of the camera device 2A in order to prevent the determination criterion of the driving assistance function from changing. The controller 11 is configured to execute the learning during driving based on a relationship between the attitude detection value and an environmental condition imaged in the imaging data, and adjust the optical axis of the camera device 2A.

The controller 11 executes the learning during driving in a region in which the environment around the vehicle 1 can be easily recognized based on the imaging data of, for example, a city in which a recognizable building and a vehicle lane are present, a highway in which the vehicle lane is clear, and a country road in which the number of target objects such as a building is small and the vehicle lane is clear, and adjusts the optical axis of the camera device 2A.

The controller 11 is configured not to execute the learning during driving in a region in which the environment around the vehicle 1 is difficult to recognize. The controller 11 does not execute the learning during driving in a region in which the environment around the vehicle 1 is difficult to recognize, such as a region in which there is a traffic jam, an environment in which there are many target objects such as another vehicle or a pedestrian, a curved road, an unpaved road, an environment in which a weather condition has changed, a vehicle lane change on a highway, a road environment in which there is no vehicle lane, and a road environment in which there is insufficient light or backlight. The controller 11 does not execute the learning during driving in a case where the attitude detection value of the attitude sensor 2C is equal to or larger than a predetermined value.

The controller 11 executes the learning during driving based on the imaging data and adjusts the optical axis of the camera device 2A in a state in which the learning during driving is enabled. The controller 11 executes the driving assistance control based on the imaging data captured based on the adjusted optical axis.

As shown in FIG. 2, the ride height of the vehicle 1 changes based on the operation of the ride height adjustment unit 6. In the example shown in the drawing, the ride height adjustment unit 6 is provided on a front wheel side of the vehicle 1, and the vehicle 1 is configured such that a front wheel side of the vehicle body is raised upward with respect to the ground T. The ride height adjustment unit 6 adjusts the ride height to be a high state in which the ride height is a predetermined ride height higher than the standard state from a low state in which the ride height is the standard state ride height, for example, within several tens of seconds based on the operation of the driver.

In a case where the ride height is in the high state, a front axle 1C side of the front wheels 1A of the vehicle body is raised around a rear axle 1D of the rear wheels 1B, and the attitude of the vehicle body changes. In a case where the ride height adjustment unit 6 is operated, the ride height changes in a short time, so that the learning during driving executed by the controller 11 may fail to keep pace. Therefore, the controller 11 is configured to adjust the optical axis of the camera device 2A in a ride height adjustment mode in a case where the ride height adjustment unit 6 is operated.

The controller 11 determines whether the ride height is in a state in which the ride height is higher than the standard state based on the detection value of the ride height of the vehicle. In a case where the controller 11 determines that the ride height is in a state in which the ride height is higher than the standard state, the controller 11 adjusts the optical axis of the camera device 2A by using the attitude-change correction value that is set in advance for the optical axis adjustment of the camera device 2A. The attitude-change correction value is a correction value that is set in advance to correct the optical axis of the camera device 2A in accordance with the ride height.

In a case where the ride height adjustment unit 6 is operated, the controller 11 acquires the detection value of the ride height detected by the ride height sensor 2B. As shown in the drawing, in a state in which the ride height adjustment unit 6 of the front axle 1C is operated, the ride height is added by a predetermined ride height H with respect to the standard state (low state), and the ride height becomes a predetermined ride height (high state). The controller 11 calculates the attitude-change correction value based on a relationship between the dimensions of the vehicle body and the ride height detection value. The attitude change of the vehicle is obtained by a change amount (predetermined ride height H) of the ride height of the lift amount on a front axle 1C side divided by the wheelbase L.

For example, in a case where the ride height is increased at the front axle 1C around the rear axle 1D in a state where the ride height adjustment unit 6 is operated, the attitude change amount θ of the vehicle 1 is calculated by a relationship of θ=arctan (H/L) based on the wheelbase L of the vehicle 1 and the predetermined ride height H. In a case where the change amount of the ride height is constant, the attitude change amount θ may be set in advance as a vehicle attitude-change correction value.

As shown in the drawing, in a case where the attitude angle of the vehicle 1 changes by the attitude change amount θ, the optical axis 2G of the low state of the camera device 2A changes to the optical axis 2H of the high state by the attitude change amount θ. In this case, the attitude-change correction value of the optical axis of the camera device 2A is equal to the attitude change amount θ of the attitude angle. In a case where the detection value is a predetermined detection value (predetermined ride height: H) indicating a predetermined ride height that is set in advance, the controller 11 calculates the attitude-change correction value (=attitude change amount: θ) based on a relationship between the change amount of the ride height and the change amount of the attitude of the vehicle body of the vehicle 1.

The controller 11 calculates the attitude change amount θ of the vehicle 1 based on the predetermined ride height H and the set value of the wheelbase L of the vehicle 1, and calculates, based on the attitude change amount, the attitude-change correction value that is set in advance for correcting the optical axis of the camera device 2A. In a case where the detection value of the ride height is a predetermined detection value indicating a predetermined ride height that is set in advance, the controller 11 adjusts the optical axis of the camera device 2A by using the attitude-change correction value corresponding to the predetermined detection value. The controller 11 adjusts the optical axis 2H after the ride height change to match the optical axis 2G before the ride height change by using the attitude-change correction value.

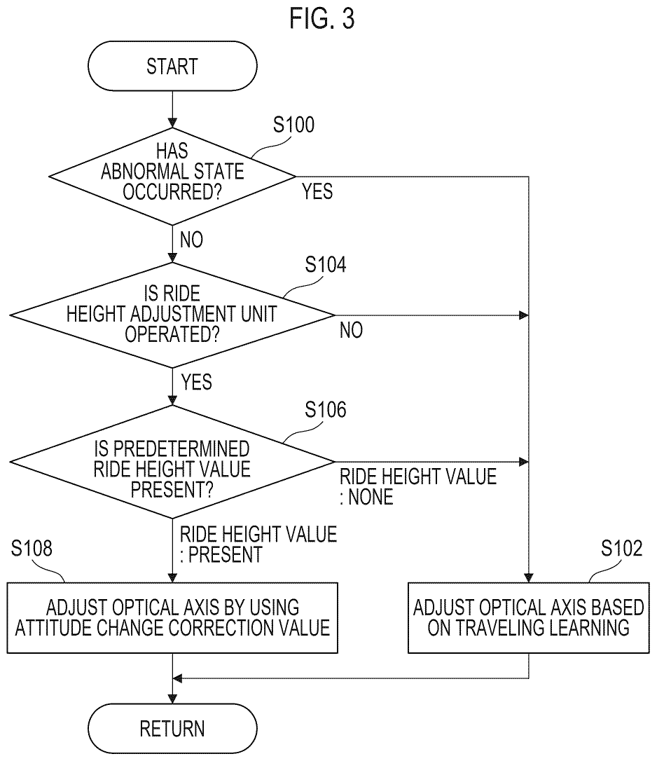

FIG. 3 shows a flow of processing of an optical axis adjustment method of the camera device 2A executed in the vehicle control device 10. The optical axis adjustment method is executed by the controller 11 that controls the camera device 2A provided in the vehicle 1 having an adjustable ride height based on a computer program installed on a computer mounted in the vehicle control device 10.

The controller 11 determines whether an abnormal state has occurred in the ride height of the vehicle 1 (S100). In a case where the controller 11 determines that the abnormality has occurred in the ride height of the vehicle 1 (S100: Yes), the controller 11 executes the learning during driving based on the imaging data captured by the camera device 2A and adjusts the optical axis of the camera device 2A (S102). In a case where the controller 11 determines that the abnormality has not occurred in the ride height of the vehicle 1 (S100: No), the controller 11 determines whether the ride height adjustment unit 6 is operated based on the operation content of the driver (S104). In a case where the controller 11 determines that the ride height adjustment unit 6 is not operated (S104: No), the controller 11 proceeds to S102, executes the determination processing based on the imaging data of the camera device 2A, and adjusts the optical axis of the camera device 2A (S102).

In a case where the controller 11 determines that the ride height adjustment unit 6 is operated (S104: Yes), the controller 11 determines whether the detection value of the ride height sensor 2B is a predetermined detection value indicating a predetermined ride height that is set in advance (S106). In a case where the detection value of the ride height sensor 2B is not obtained, that is, in a case where the ride height of the vehicle 1 is in the low state (S106 ride height value: none), the controller 11 proceeds to S102, executes the determination processing based on the imaging data of the camera device 2A, and adjusts the optical axis of the camera device 2A (S102).

In a case where the detection value of the ride height sensor 2B is present and the controller 11 determines that the ride height is in a state in which the ride height is higher than the standard state (S106 ride height value: present), the controller 11 adjusts the optical axis of the camera device 2A by using the attitude-change correction value that is set in advance for correcting the optical axis of the camera device in accordance with the ride height (S108). The controller 11 returns the processing to S100 and continues the processing of adjusting the optical axis of the camera device 2A.

As described above, according to the vehicle control device 10, when the ride height of the vehicle 1 equipped with a ride height adjustment unit 6 temporarily changes, the computational processing in the calibration for adjusting the optical axis of the camera device 2A can be simplified as compared with the normal processing of executing the learning during driving based on the imaging data and adjusting the optical axis of the camera device 2A. According to the vehicle control device 10, in a case where the ride height of the vehicle 1 is lifted up to the predetermined ride height H that is set in advance, the optical axis of the camera device 2A can be easily adjusted by adjusting the optical axis of the camera device 2A by using the attitude-change correction value θ that is set in advance in accordance with the predetermined ride height H.

In the embodiment described above, the computer program executed in each configuration of the vehicle control device 10 may be provided in a form of being recorded on a computer-readable portable recording medium such as a semiconductor memory, a magnetic recording medium, or an optical recording medium. The computer program product including the computer program according to the embodiment described above may be stored in a storage medium or provided via a communication line.

What is claimed is:

1. A vehicle control device comprising a controller configured to control a camera device provided in a vehicle having a ride height that is adjustable, wherein the controller is configured to adjust, when determination is made that the vehicle is in a state in which the ride height is higher than a standard state based on a detection value of the ride height of the vehicle, an optical axis of the camera device by using an attitude-change correction value that is set in advance for correcting the optical axis of the camera device in accordance with the ride height.

2. The vehicle control device according to claim 1, wherein the controller is configured to adjust, when the detection value is a predetermined detection value indicating the ride height that is predetermined and set in advance, the optical axis by using the attitude-change correction value that is set in advance in accordance with the predetermined detection value.

3. The vehicle control device according to claim 2, wherein the controller is configured to
calculate an attitude change amount of the vehicle based on the predetermined detection value and a set value of a wheelbase of the vehicle, and
calculate the attitude-change correction value based on the attitude change amount.

4. The vehicle control device according to claim 1, wherein the controller is configured to execute, when the detection value is not acquired, determination processing based on imaging data of the camera device to adjust the optical axis of the camera device.

5. A non-transitory storage medium storing a computer program installed on a computer that is configured to control a camera device provided in a vehicle having a ride height that is adjustable, the program causing the computer to execute adjusting, when determination is made that the vehicle is in a state in which the ride height is higher than a standard state based on a detection value of the ride height of the vehicle, an optical axis of the camera device by using an attitude-change correction value that is set in advance for correcting the optical axis of the camera device in accordance with the ride height.
